(19) United States
(12) Patent Application Publication
(10) Pub. No.: US 2007/0180744 A1
(43) Pub. Date: Aug. 9, 2007

(54) Folding volumetric display

(75) Inventor: Joe Babas, New York, NY (US)

Correspondence Address: OSTROLENK FABER GERB & SOFFEN, 1180 AVENUE OF THE AMERICAS, NEW YORK, NY, 100368403, US

(73) Assignee: POPS 3D LLC

(21) Appl. No.: 11/350,988

(22) Filed: Feb. 9, 2006

(51) Int. Cl. G09F 1/00

(52) U.S. Cl. 40/124.19

(57) ABSTRACT

A three-dimensional device for displaying indicia comprises multiple planar layers whose tabbed sides are bounded by planar side panels with shots to form a hinging mechanism which when fully open forms a rectangular parallelepiped. The apparatus can be employed to reconstitute cross sectional information from a given three-dimensional form to create an illusion of that form in space. It can also display a wide range of different visual effects that include the use of photographic imagery, text, specialty inks and die-cutting. The display can be effectively viewed in the round, and it folds flat to store or mail.

### CROSS-REFERENCE TO RELATED APPLICATION

This application is related to Ser. No. ______ filed by the same inventor on even date herewith, titled PASSIVE MULTI-PLANAR VOLUMETRIC DISPLAYS AND METHODS FOR THEIR CONSTRUCTION, Attorney Docket P/3659-3, incorporated by reference.

### BACKGROUND OF THE INVENTION

The present invention relates to display structures, particularly to passive three-dimensional displays utilizing multiple layers to create imagery.

Three-dimensional or “volumetric” displays are well-known in the art. The term can be applied to embodiments that range from inexpensive novelties such as cardboard pop-up greeting cards to expensive, computer-controlled viewing devices that are being developed for military, scientific and graphics applications and are designed around liquid crystal displays, cathode ray tubes and holographic elements.

While the inexpensive volumetric displays are simple in construction and design, they are restricted to providing, at best, an indication of perspective or a simple illusion of depth. The expensive, technologically complex displays, on the other hand, offer not only the illusion of form in space but also the illusion of full motion in three dimensions.

Displays of this general nature are not new. U.S. Pat. No. 2,565,553 describes curved transparent layers with indicia arranged in such a way as to indicate perspective. The device is relatively complicated to manufacture and doesn't have the ability to create an illusion of a three-dimensional object in space. U.S. Pat. No. 3,314,180 discloses a picture assembly consisting of parallel transparent layers among which image attributes such as tone, color and outline are distributed. But this device is complicated in its construction, and it depends on a vibrating mechanism to help achieve a three-dimensional effect. U.S. Pat. No. 3,829,998 discloses tabbed transparent layers in a boxlike structure—open in front, closed in back—that holds them in registration. This embodiment allows the device to be folded flat to store or mail, but its structure effectively limits the number of layers the device can hold which, in turn, limits its use to indicating a simple illusion of depth but not the illusion of form in space. The closed box also restricts the point of view and would be relatively expensive to manufacture. U.S. Pat. No. 4,134,104 describes a device for displaying information in three-dimensions, but its transparent layers must be held in a rigid frame which restricts its applications. U.S. Pat. No. 4,173,391 describes a volumetric display of the type which is capable of creating the illusion of a three-dimensional form in space, but its stacked fiber optic panels are technically complex and expensive to manufacture. U.S. Pat. No. 5,181,745 discloses an economical printing method for the manufacture of imagery capable of producing an illusion of depth, but it is not capable of producing the illusion of form in space. Another method of producing an illusion of depth is described in U.S. Pat. No. 5,367,801. This device displays foreground, middle ground and background imagery on three separate layers. The layers can be transparent or they can be treated to give some special visual effect, but they can't create the illusion of form in space.

A device that is capable of presenting the illusion of three-dimensional form in space, that is capable of displaying other visual effects, that is flexibly configured and inexpensive to manufacture would be of value in the marketplace for novelties, greeting cards, gift items, promotion, point-of-purchase display and advertising.

### SUMMARY OF THE INVENTION

The present invention provides a folding volumetric display that is capable of creating the illusion of three-dimensional form in space, has the ability to create other visual effects by employing a wide range of graphic techniques and can be viewed effectively in the round. It is simple in design and construction, inexpensive to manufacture and folds flat to store or mail.

The invention concerns a folding volumetric display comprised of multiple planar layers arrayed in a parallel manner and held in place by two planar side panels. Each layer is configured with tabs on opposing sides which engage corresponding slots in the side panels thereby forming an integral hinging mechanism. The display is designed in such a way that it stores flat and when fully opened forms a rectangular parallelepiped.

It is a primary object of the present invention to provide a display that can be flexibly configured in terms of its size, the number of layers it comprises and also in terms of the layers' spacing, since spacing, edge treatment and image resolution are interrelated. In this regard, a display is comprised of only two discrete design elements—a layer element and a side panel element. This simplicity of design reduces production costs since no matter the number of layers needed to comprise an assembled display, only two dies are needed to cut its elements, one for the layers and one for the side panels.

It is another object of this invention to provide a tab and slot mechanism whose configuration accommodates materials of varying thickness, that comprises a hinging action for the folding display and whose design not only allows for the easy assembly of the device, but also provides strain relief for the die-cut elements.

It is a further object of the present invention to provide a display whose flexibility, scalability and ease of manufacture makes it applicable to a wide range of markets including novelties, greeting cards, gift items, promotion, point-of-purchase display and advertising.

Other objects and features of the invention are explained below with reference to the attached drawings.

### BRIEF DESCRIPTION OF THE DRAWINGS

FIG. 1 is an elevational view of a typical planar layer with tabs symmetrically configured on opposing sides.

FIG. 2 is an elevational view of a typical side panel with its slots configured to receive the corresponding tabs of the planar layers.

FIG. 3 is an isometric drawing of a fully open folding volumetric display comprised of seven transparent layers and two transparent side panels which have been tinted grey.

FIG. 4 is an elevational view of seven planar layers which in this embodiment comprise the volumetric display of a heart whose outline is rendered in cross sections represented by contour lines.

FIG. 5 is an elevational view of a fully open display forming the three-dimensional image of a heart whose outline is rendered in cross sections represented by contour lines.

FIG. 6 is an isometric drawing of a fully open display comprised of seven transparent layers forming the three-dimensional image of a heart whose outline is rendered in cross sections represented by contour lines.

FIG. 7 is a schematic drawing showing a volumetric display fully open in the form of a rectangular parallelepiped.

FIG. 8 is a schematic drawing showing a display that is partly closed.

FIG. 9 is a schematic drawing showing a display that is folded flat.

FIG. 10 is an elevational view of a volumetric display that is folded flat. It contains seven cross sections of a heart rendered in contour lines.

FIG. 11 is an elevational view of a typical slot that accommodates thick material.

FIG. 12 is an elevational view of a typical slot that accommodates thin material.

FIG. 13 is an elevational view of a typical tab.

FIG. 14 is an isometric drawing from the front of a disengaged tab and slot. The tab is opaque. The slot is cut in transparent material.

FIG. 15 is an isometric drawing from the front of a partly engaged tab and slot.

FIG. 16 is an isometric drawing from the front of a fully engaged tab and slot.

FIG. 17 is an isometric drawing from the back of a disengaged tab and slot.

FIG. 18 is an isometric drawing from the back of a partly engaged tab and slot.

FIG. 19 is an isometric drawing from the back of a fully engaged tab and slot.

### DESCRIPTION OF AN EMBODIMENT OF THE INVENTION

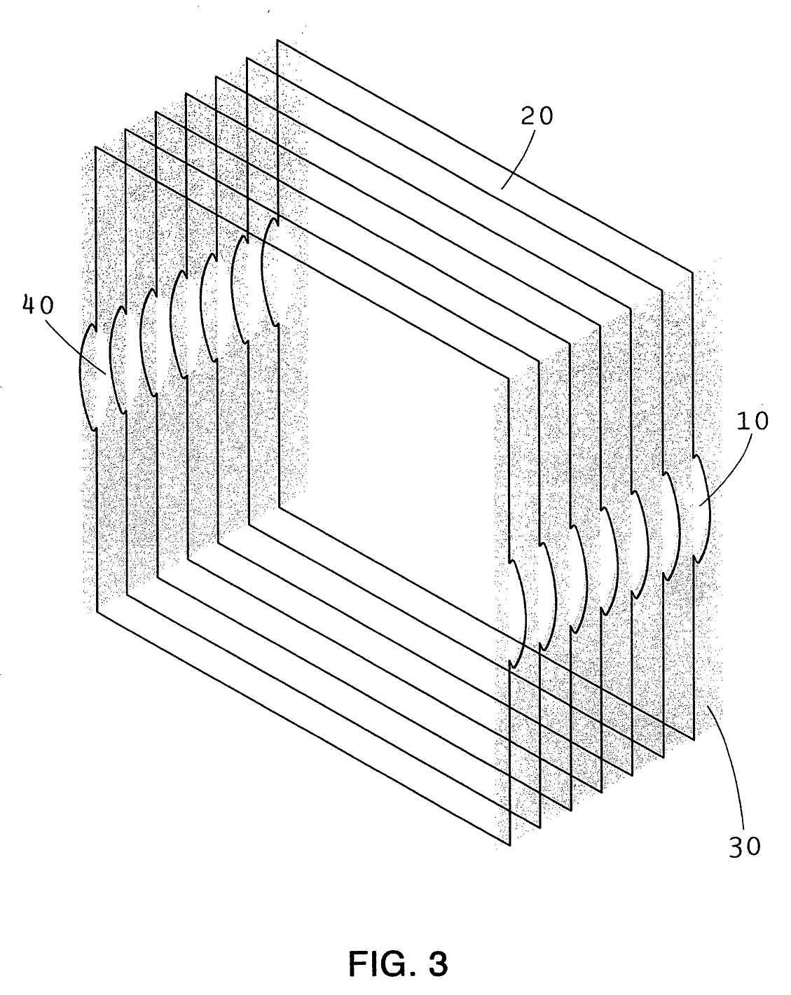

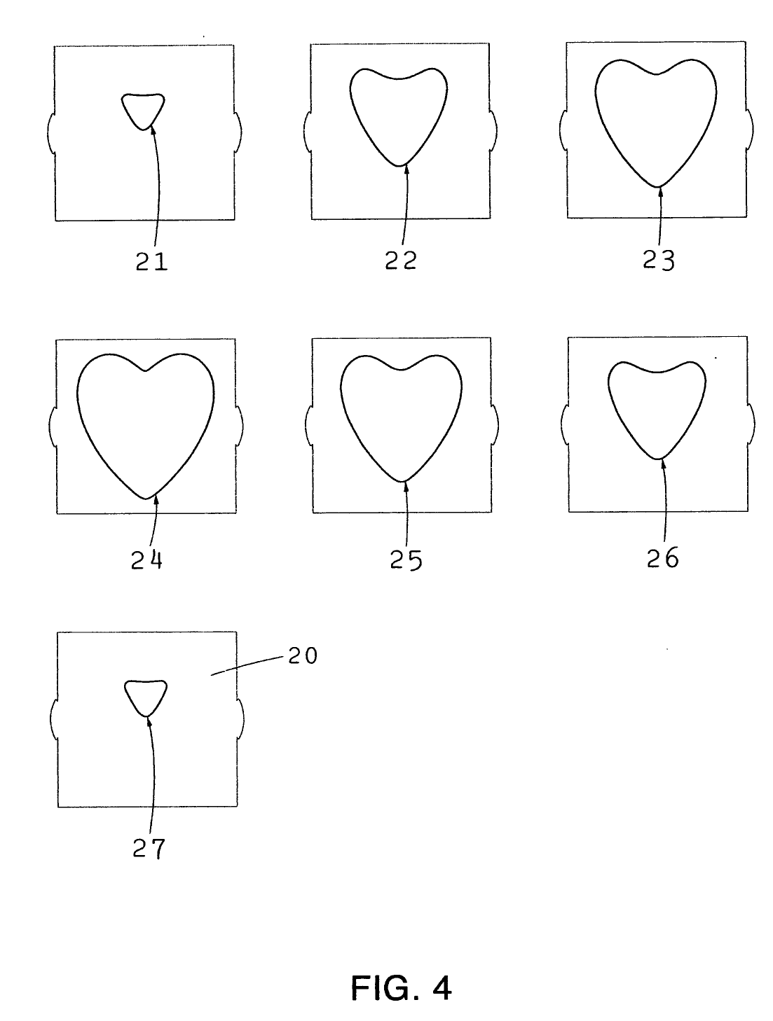

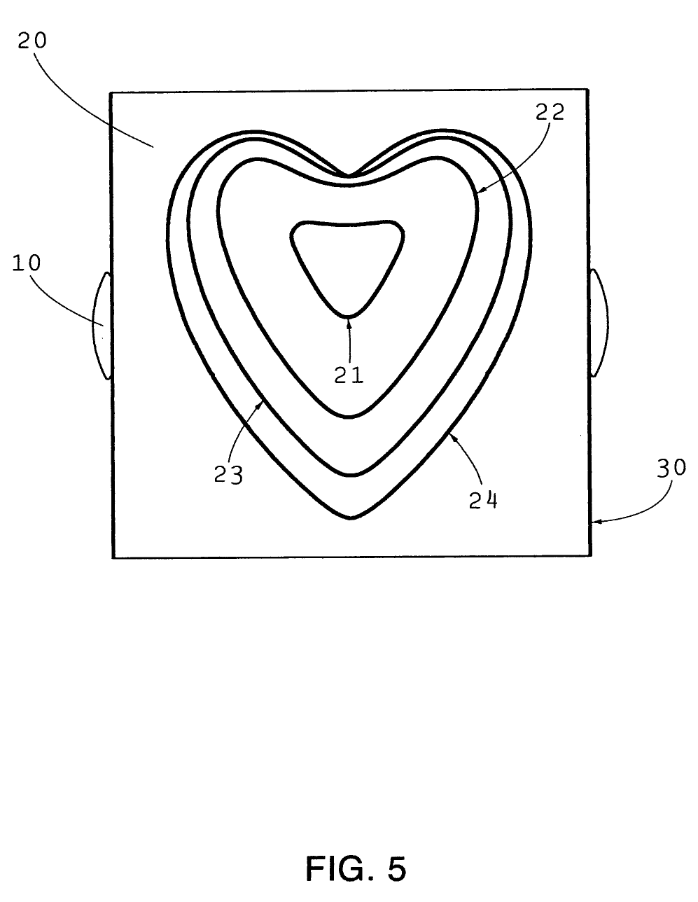

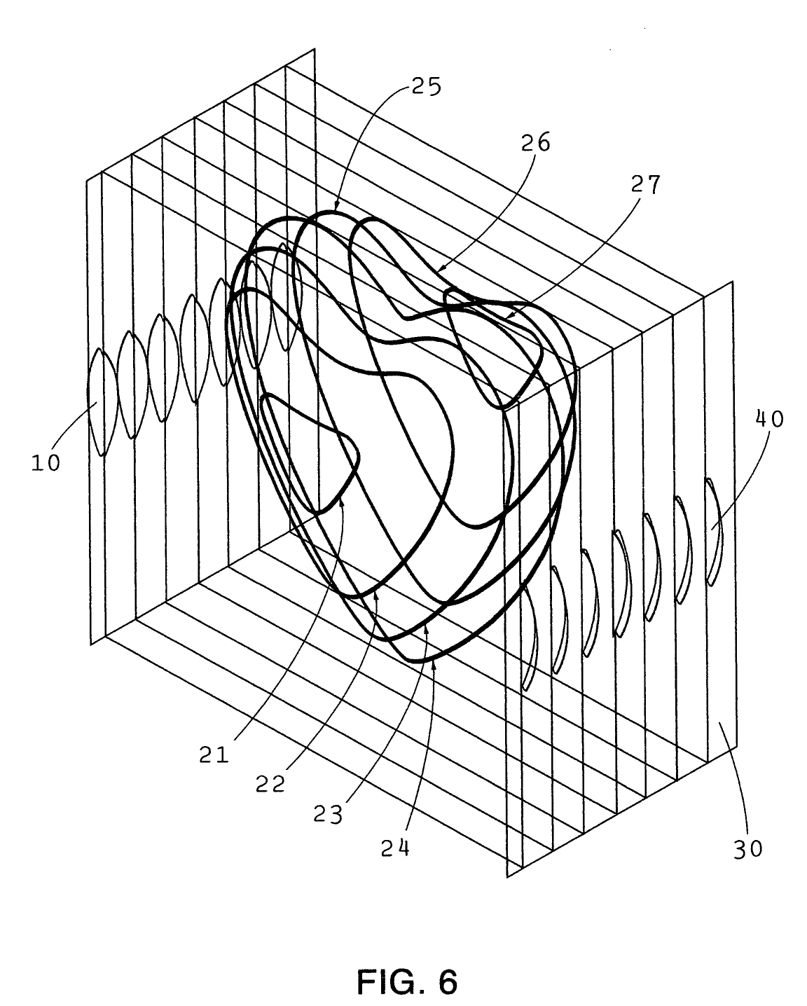

A folding volumetric display of the type shown in FIGS. 3 and 6 can incorporate a wide range of graphic techniques, and it can be comprised, theoretically, of any number of layers 20 whose attributes, including material composition, size and proportion, can be prescribed to satisfy particular design parameters.

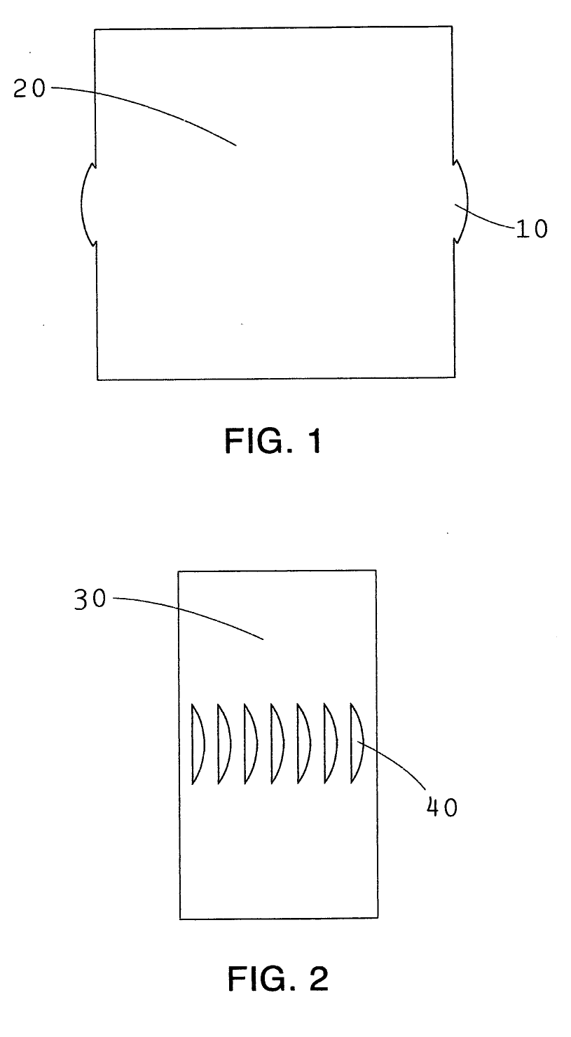

For simplicity of disclosure and visualization, this embodiment is shown as having square layers 20 of indeterminate dimension as in FIG. 1 comprised of some common transparent material such as acetate or polyester and it displays an image of a heart whose outline is rendered in seven cross sections 21, 22, 23, 24, 25, 26, 27 indicated by contour lines.

Advantageously, the images on the respective layers can be generated by the techniques disclosed in the above-mentioned Ser. No. ______ (P/3659-3).

An assembled volumetric display shown in FIGS. 3 and 6 is comprised of only two discrete design elements, a planar layer element 20 and a planar side panel element 30. The layer element has tabs 10 affixed on opposing sides and the side panel is perforated with slots 40 to accept the tabs 10.

The layer tabs 10 are configured symmetrically at the vertical midpoint of two opposing sides on the layer elements 20. The tab 10 comprises two shoulders 11, two adjacent tips 12 and an adjacent outer edge 13. The two shoulders 11 extend from the body of the layer 20 at a substantially acute angle. The tips 12 of the tab are rounded and they merge with an edge 13 which can be linear or curvilinear in form. See FIG. 13.

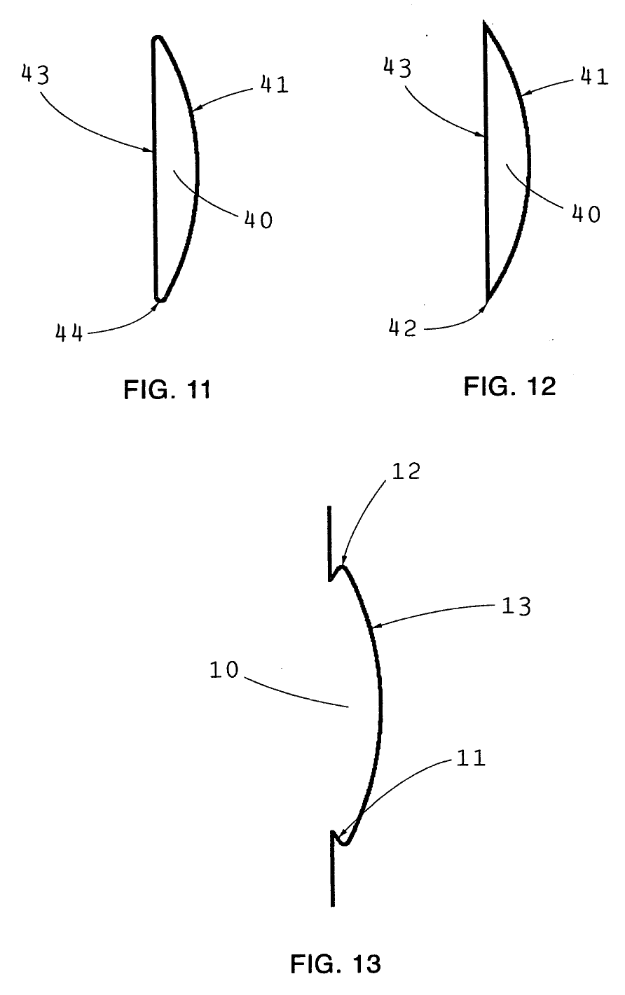

The slots 40 are configured along a line at the vertical midpoint of the side panels 30. A typical slot 40 as disclosed in FIG. 11 comprises a linear side 43, a curvilinear side 41 and two rounded corners 44 configured to accept tabs 10 of a substantially thick material. A typical slot 40 as disclosed in FIG. 12 comprises a linear side 43, a curvilinear side 41 and two corners 42 forming an acute angle configured to accept tabs 10 of a substantially thin material.

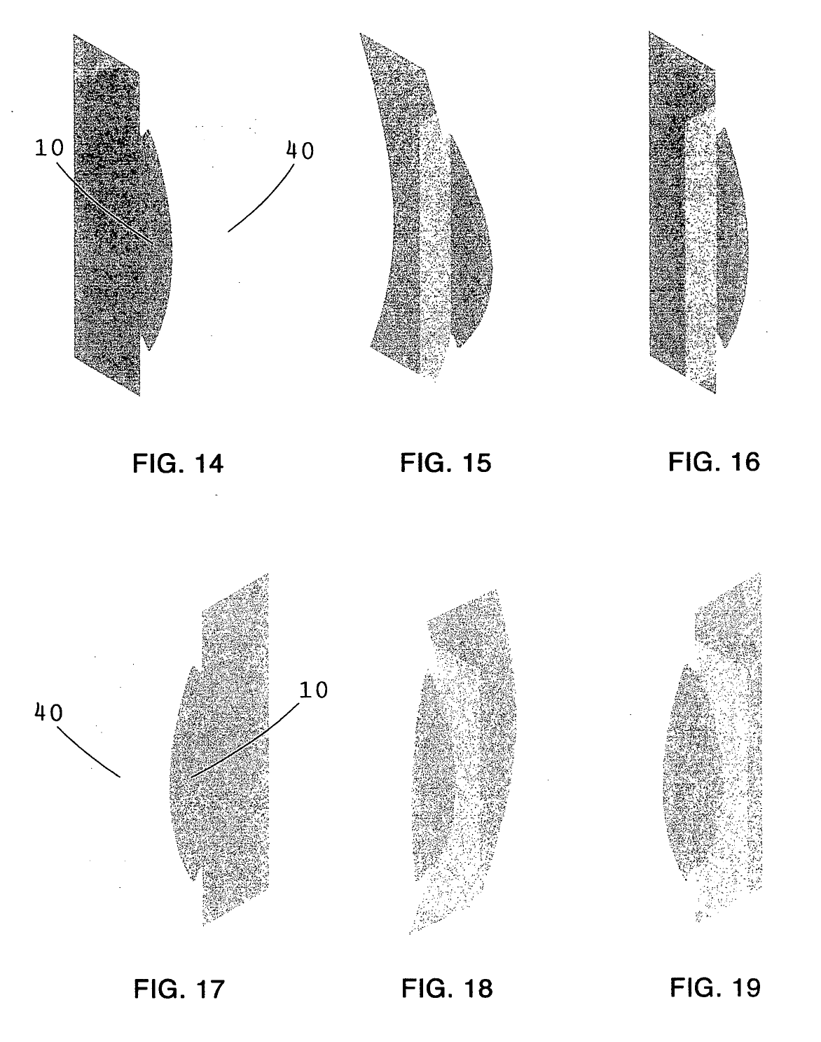

A typical tab 10 is disclosed in FIG. 13. It is configured in such a way that the distance from the base of the shoulder 11 where it intersects the body of the layer 20 to the furthest point of the curve which comprises the opposite tip 12 is slightly less than the length of the arc formed by the curvilinear side 41 of the slot 40. This configuration allows for a method of assembly whereby one rounded tip 12 of the tab 10 is passed through the slot 40 on an axis substantially perpendicular to the plane of the side panel 30 until a corner of the slot 42 or 44 engages the base of the shoulder 11 of the tab 10 where it intersects the body of the layer 20. The layer 20 is then deformed into a curve, either by hand or by machine, so that as the shape of the curve of the tab 10 approximates the shape of the curvilinear side 41 of the slot 40, the body of the tab 10, facilitated by the fact that its corner is rounded, easily passes through the slot 40. When the force deforming the layer 20 is removed, the tab 10 regains its planar character and fully engages the slot 40. This process is disclosed in a series of isometric drawings in FIGS. 14, 15, 16, 17, 18 and 19.

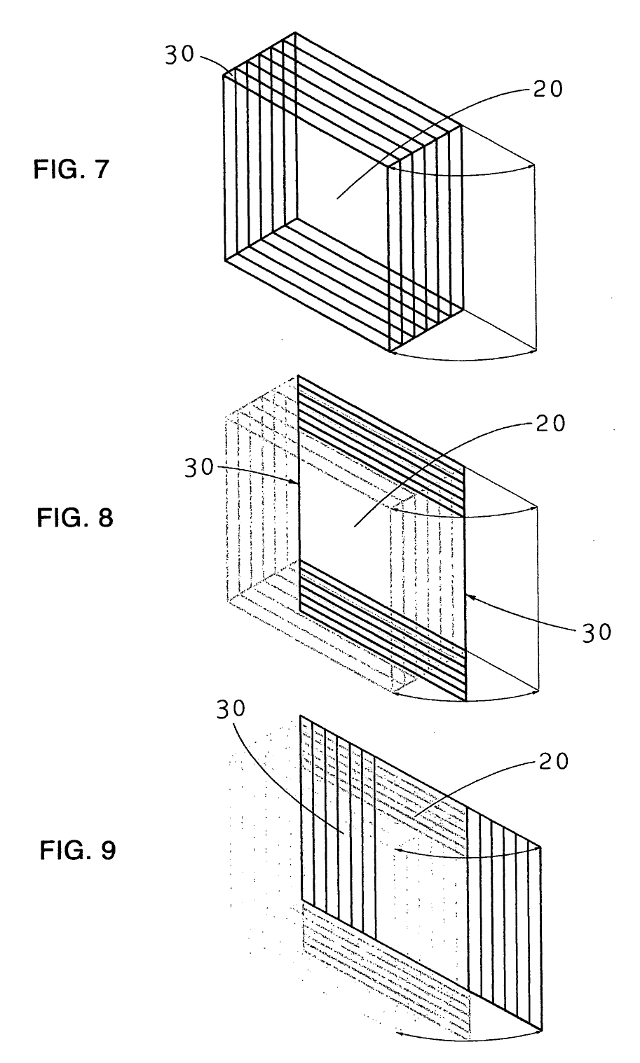

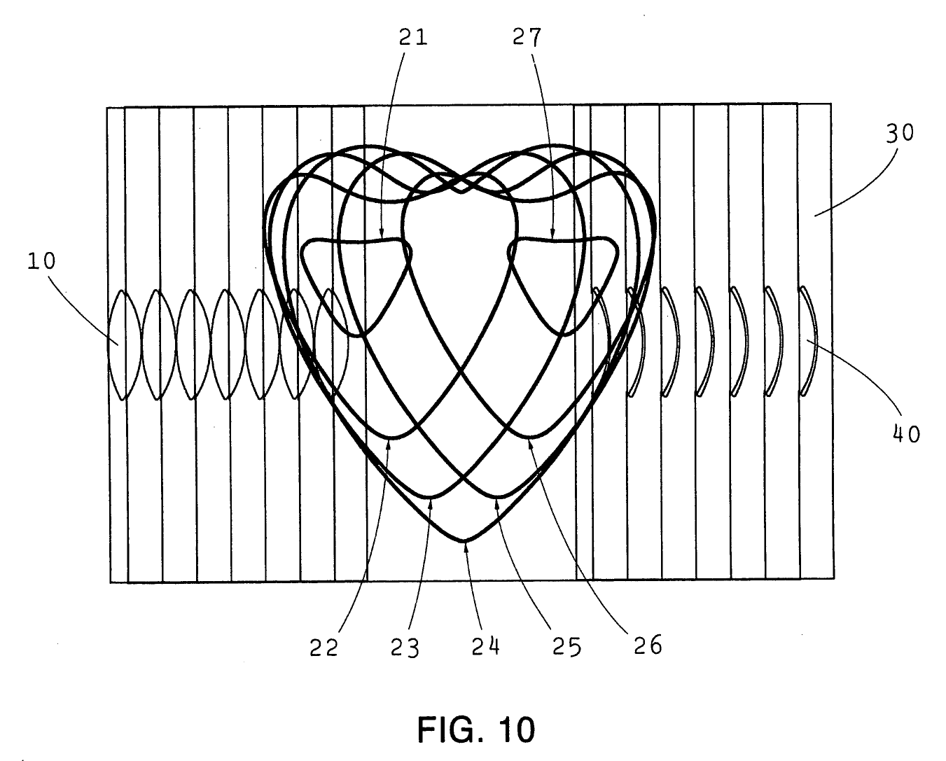

The angled shoulder 11 of the tab 10 cooperates with either slot corner 42 or 44 to comprise an accommodating mechanism. The rounded corners 44 of the slot in FIG. 11 provide substantial clearance for thicker materials. The acutely angled corners 42 of the slot in FIG. 12 provide support to hold thinner materials more firmly in position. The essentially frictionless fit between the tab 10 and the slot 40 not only eases the assembly process and provides strain relief for the die-cut materials of the planar layers 20 and planar side panels 30, it also allows the display to maintain any given configuration from fully open in FIGS. 3 and 6 to fully closed in FIGS. 9 and 10 without binding. The flexibility of the tab and slot mechanism allows the individual layers 20 to rotate through an angle approaching one hundred and eighty degrees as shown in FIGS. 7, 8 and 9, relative to the face of the side panel 30, about vertical axes defined by conjoining lines drawn, essentially, through the linear sides 43 of the slots 40. This rotational ability allows the assembled tab and slot mechanism to act as a hinge and allows the assembled displays in FIGS. 3 and 6 to fold flat from their fully open position as rectangular parallelepipeds. Even though the hinge mechanism comprised of the assembled tab 10 and slot 40 is flexible and essentially frictionless, cooperation of the multiple layers 20 makes it difficult for an individual tab 10 to disengage from its slot 40. This synergism gives the assembled display its structural intregrity.

The folding volumetric display as described above is capable of creating the illusion of three-dimensional form. It has the ability to create other visual effects by employing a wide range of graphic techniques. It can be effectively viewed in the round. It is flexibly configured in its design and construction and inexpensive to manufacture. It also folds flat to store or mail.

Although the present invention has been described in relation to a particular embodiment thereof, many other variations and modifications and other uses will become apparent to those skilled in the art. Therefore, the present invention is not limited by the specific disclosure herein.

What is claimed is:

1. A folding volumetric display comprising:
a plurality of substantially planar transparent layers having indicia thereon;
a pair of side panels for supporting said layers, each layer having a pair of opposite sides, each of said opposite sides being connected by a respective hinge to a corresponding one of said side panels;
said hinges having a first position in which said layers and side panels are folded together substantially flat; and
said hinges having a second position in which said layers are disposed spaced apart from each other.

2. The folding volumetric display of claim 1, wherein said layers are substantially parallel to each other and perpendicular to said side panels, when said hinges are in said second position.

3. The folding volumetric display of claim 1, wherein said indicia on the respective layers are disposed in a predetermined viewing arrangement, when said hinges are in said second position.

4. The folding volumetric display of claim 3, wherein the respective indicia on each said layer comprise a corresponding cross-sectional view of an object to be displayed, such that said predetermined viewing arrangement of said indicia provides a 3-dimensional view of said object.

5. The folding volumetric display of claim 1, wherein each said hinge comprises a tab on the respective layer engaged in a slot on the corresponding side panel.

6. A volumetric display method comprising:
placing respective indicia on a plurality of substantially planar transparent layers;
supporting said layers on a pair of side panels, each layer having a pair of opposite sides, and connecting each of said opposite sides by a respective hinge to a corresponding one of said side panels;
said hinges having a first position in which said layers and side panels are folded together substantially flat; and
said hinges having a second position in which said layers are disposed spaced apart from each other.

7. The volumetric display method of claim 6, wherein said layers are substantially parallel to each other and perpendicular to said side panels, when said hinges are in said second position.

8. The volumetric display method of claim 6, wherein said indicia on the respective layers are disposed in a predetermined viewing arrangement, when said hinges are in said second position.

9. The volumetric display method of claim 8, wherein the respective indicia on each said layer comprise a corresponding cross-sectional view of an object to be displayed, such that said predetermined viewing arrangement of said indicia provides a 3-dimensional view of said object.

10. The volumetric display method of claim 6, wherein each said hinge comprises a tab on the respective layer engaged in a slot on the corresponding side panel.
